(19) United States
(12) Patent Application Publication
(10) Pub. No.: US 2020/0260274 A1
(43) Pub. Date: Aug. 13, 2020

(54) MULTI-OPERATOR PERSONALIZATION AT A SINGLE STOCK KEEPING UNIT

(71) Applicant: QUALCOMM Incorporated, San Diego, CA (US)

(72) Inventors: Naga Chandan Babu Gudivada, Hyderabad (IN); Rajendra Prasad Nelurouth, Hyderabad (IN); Venkata Durga Vinod Chikkala, Hyderabad (IN); Phani Pradeep Kumar Kothapalli Venkata, Hyderabad (IN); Venkata Konda Reddy Reddem, San Diego, CA (US)

(21) Appl. No.: 16/773,811

(22) Filed: Jan. 27, 2020

Related U.S. Application Data
(60) Provisional application No. 62/804,424, filed on Feb. 12, 2019.

(51) Int. Cl. H04W 12/06; H04W 12/04; H04W 12/00; H04L 29/06

(52) U.S. Cl. CPC H04W 12/06; H04W 12/04; H04L 2209/80; H04L 63/0853; H04W 12/0023

(57) ABSTRACT

Methods, systems, and devices for wireless communication are described. Generally, the described techniques provide for efficiently personalizing or locking a user equipment (UE) for operation with a specific operator. For example, a manufacturer may load multiple operator configurations associated with multiple operators in UE storage such that the UE may support operation with any of the multiple operators. The UE may then allow a user to select an operator from the multiple operators, and the UE may select and apply an operator configuration corresponding to the selected operator to lock the UE for operation with the selected operator. Thus, using these techniques, a user may be able to dynamically personalize or lock a UE for operation with a selected operator. Further, after being personalized or locked for operation with one operator, a UE may be more easily re-personalized or locked for operation with a different operator.

### CROSS REFERENCE

The present Application for Patent claims the benefit of U.S. Provisional Patent Application No. 62/804,424 by GUDIVADA et al., entitled “MULTI-OPERATOR PERSONALIZATION AT A SINGLE STOCK KEEPING UNIT,” filed Feb. 12, 2019, assigned to the assignee hereof, and expressly incorporated herein.

### BACKGROUND

The following relates generally to wireless communications and more specifically to multi-operator personalization at a single stock keeping unit (SKU).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

A wireless multiple-access communications system may include a number of base stations or network access nodes, each simultaneously supporting communication for multiple communication devices, which may be otherwise known as user equipment (UE). A UE may be referred to as an SKU, and UEs or SKUs may be manufactured by original equipment manufacturers (OEMs) or original design manufacturers (ODMs). OEMs or ODMs may personalize or lock UEs for operation with specific operators at the factory. Conventional techniques for personalizing or locking UEs for operation with specific operators may be deficient.

### SUMMARY

The described techniques relate to improved methods, systems, devices, and apparatuses that support multi-operator personalization at a single stock keeping unit (SKU). Generally, the described techniques provide for efficiently personalizing or locking a UE or SKU for operation with a specific operator. A manufacturer may load multiple operator configurations associated with multiple operators in UE storage such that the UE may support operation with any of the multiple operators. The UE may then allow a user to select an operator from the multiple operators, and the UE may select and apply an operator configuration corresponding to the selected operator to lock the UE for operation with the selected operator. Thus, using these techniques, a user may be able to dynamically personalize or lock a UE for operation with a selected operator. Further, after being personalized or locked for operation with one operator, a UE may be re-personalized or locked for operation with a different operator without being sent back to the factory (e.g., since an operator configuration for the different operator may be stored at the UE).

A method for wireless communication at a UE is described. The method may include receiving an indication of an operator selected for the UE from a set of operators, receiving an operator configuration corresponding to the selected operator, the operator configuration including an operator agent, locking the UE for operation via the selected operator by applying the operator configuration corresponding to the selected operator, and communicating with a server of the selected operator using the operator agent to activate service with the operator.

An apparatus for wireless communication at a UE is described. The apparatus may include a processor, memory in electronic communication with the processor, and instructions stored in the memory. The instructions may be executable by the processor to cause the apparatus to receive an indication of an operator selected for the UE from a set of operators, receive an operator configuration corresponding to the selected operator, the operator configuration including an operator agent, lock the UE for operation via the selected operator by applying the operator configuration corresponding to the selected operator, and communicate with a server of the selected operator using the operator agent to activate service with the operator.

Another apparatus for wireless communication at a UE is described. The apparatus may include means for receiving an indication of an operator selected for the UE from a set of operators, receiving an operator configuration corresponding to the selected operator, the operator configuration including an operator agent, locking the UE for operation via the selected operator by applying the operator configuration corresponding to the selected operator, and communicating with a server of the selected operator using the operator agent to activate service with the operator.

A non-transitory computer-readable medium storing code for wireless communication at a UE is described. The code may include instructions executable by a processor to receive an indication of an operator selected for the UE from a set of operators, receive an operator configuration corresponding to the selected operator, the operator configuration including an operator agent, lock the UE for operation via the selected operator by applying the operator configuration corresponding to the selected operator, and communicate with a server of the selected operator using the operator agent to activate service with the operator.

In some examples of the method, apparatuses, and non-transitory computer-readable medium described herein, receiving the operator configuration corresponding to the selected operator may include operations, features, means, or instructions for selecting and enabling the operator configuration corresponding to the selected operator.

In some examples of the method, apparatuses, and non-transitory computer-readable medium described herein, receiving the operator configuration corresponding to the selected operator may include operations, features, means, or instructions for receiving a personalization configuration corresponding to the selected operator and utilizing the personalization configuration to check codes saved at the UE for a set of personalization categories against codes retrieved from a subscriber identity module (SIM) inserted at the UE. In some examples of the method, apparatuses, and non-transitory computer-readable medium described herein, a set of personalization configurations corresponding to the set of operators may be stored in secure file storage at the UE, and where the received personalization configuration may be one of the set of personalization configurations.

In some examples of the method, apparatuses, and non-transitory computer-readable medium described herein, receiving the operator configuration corresponding to the selected operator may include operations, features, means, or instructions for receiving a public key corresponding to the selected operator and utilizing the public key to validate signatures of messages received from the server of the selected operator or to encrypt responses to the server of the selected operator. In some examples of the method, apparatuses, and non-transitory computer-readable medium described herein, a set of public keys corresponding to the set of operators may be stored in secure file storage at the UE, and where the received public key may be one of the set of public keys.

In some examples of the method, apparatuses, and non-transitory computer-readable medium described herein, a set of operator agents corresponding to the set of operators may be stored in a trust zone at the UE, and where the received operator agent may be one of the set of operator agents. In some examples of the method, apparatuses, and non-transitory computer-readable medium described herein, an operator agent, personalization configuration, and public key corresponding to each operator of the set of operators may be bound together with a unique reference key. In some examples of the method, apparatuses, and non-transitory computer-readable medium described herein, receiving the operator configuration corresponding to the selected operator may include operations, features, means, or instructions for selecting a reference key corresponding to the selected operator, and receiving the operator configuration corresponding to the selected operator using the reference key.

In some examples of the method, apparatuses, and non-transitory computer-readable medium described herein, the UE may be locked for operation via the selected operator during deployment or as part of a re-personalization procedure. In some examples of the method, apparatuses, and non-transitory computer-readable medium described herein, the UE includes a universal integrated circuit card (UICC) supporting the set of operators. In some examples of the method, apparatuses, and non-transitory computer-readable medium described herein, the UE may be a single SKU, the single SKU supporting the set of operators and being dynamically configured for operation via the selected operator. In some examples of the method, apparatuses, and non-transitory computer-readable medium described herein, the UE may be a single SKU.

### BRIEF DESCRIPTION OF THE DRAWINGS

FIG. 1 illustrates an example of a wireless communications system that supports multi-operator personalization at a single stock keeping unit (SKU) in accordance with aspects of the present disclosure.

FIG. 2 illustrates an example of a user interface at a user equipment (UE) that supports multi-operator personalization at a single SKU in accordance with aspects of the present disclosure.

FIG. 3 illustrates an example of a flowchart that supports multi-operator personalization at a single SKU in accordance with aspects of the present disclosure.

FIG. 4 illustrates an example of a flowchart that supports multi-operator personalization at a single SKU in accordance with aspects of the present disclosure.

FIGS. 5 and 6 show block diagrams of devices that support multi-operator personalization at a single SKU in accordance with aspects of the present disclosure.

FIG. 7 shows a block diagram of a communications manager that supports multi-operator personalization at a single SKU in accordance with aspects of the present disclosure.

FIG. 8 shows a diagram of a system including a device that supports multi-operator personalization at a single SKU in accordance with aspects of the present disclosure.

FIGS. 9 and 10 show flowcharts illustrating methods that support multi-operator personalization at a single SKU in accordance with aspects of the present disclosure.

### DETAILED DESCRIPTION

Some wireless communications systems may support communications between user equipment (UEs) and operator networks. A UE may be referred to as an SKU, and UEs or SKUs may be manufactured by original equipment manufacturers (OEMs) or original design manufacturers (ODMs). OEMs or ODMs may personalize or lock a UE for operation with a specific operator at the factory. As such, an operator may sell UEs personalized or locked for operation with its networks at a subsidized price (i.e., the operator may work with OEMs or ODMs to subsidize its UEs). In some cases, however, it may be challenging for an operator to anticipate sales. As a result, an OEM or ODM may manufacture a surplus of UEs for the operator and, since the UEs may be personalized or locked for operation with the operator, the UEs may only support operation with that operator. Accordingly, the UEs may have to be sent back to the factory to be re-personalized or locked for operation with another operator, resulting in inefficiencies and increased costs at the manufacturer.

As described herein, a UE or a component within the UE may support efficient techniques for dynamically personalizing or locking the UE for operation with a specific operator (e.g., based on user input) to limit the costs associated with re-personalizing or locking the UE for operation with another operator (e.g., if the UE does not sell). For example, a manufacturer may load multiple operator configurations associated with multiple operators in UE storage such that the UE may support operation with any of the multiple operators. The UE may then allow a user to select an operator from the multiple operators, and the UE may select and apply an operator configuration corresponding to the selected operator to lock the UE for operation with the selected operator. Thus, using these techniques, a user may be able to dynamically personalize or lock a UE for operation with a selected operator. Further, after being personalized or locked for operation with one operator, a UE may be re-personalized or locked for operation with a different operator without being sent back to the factory (e.g., since an operator configuration for the different operator may be stored at the UE).

Particular aspects of the subject matter described herein may be implemented to realize one or more advantages. The described techniques may support improvements in product manufacturing and delivery such that OEMs or ODMs may avoid inefficiently returning a UE to a factory for re-personalization. The described techniques may also promote enhanced UE flexibility associated with its multi-operator capability, which may also be implemented to realize one or more advantages for a user. For example, an embodiment of the present disclosure may enable a user to switch operators without switching UEs. For instance, the user may have a UE associated with operator configurations for a first operator and a second operator and may, accordingly, switch between the first operator and the second operator without getting a new UE for the second operator. As such, the user may save time and cost associated with getting a new UE when switching operators.

Aspects of the disclosure introduced herein are described in the context of a wireless communications system. Examples of processes and signaling exchanges that support multi-operator personalization at a single SKU are then described. Aspects of the disclosure are further illustrated by and described with reference to apparatus diagrams, system diagrams, and flowcharts that relate to multi-operator personalization at a single SKU.

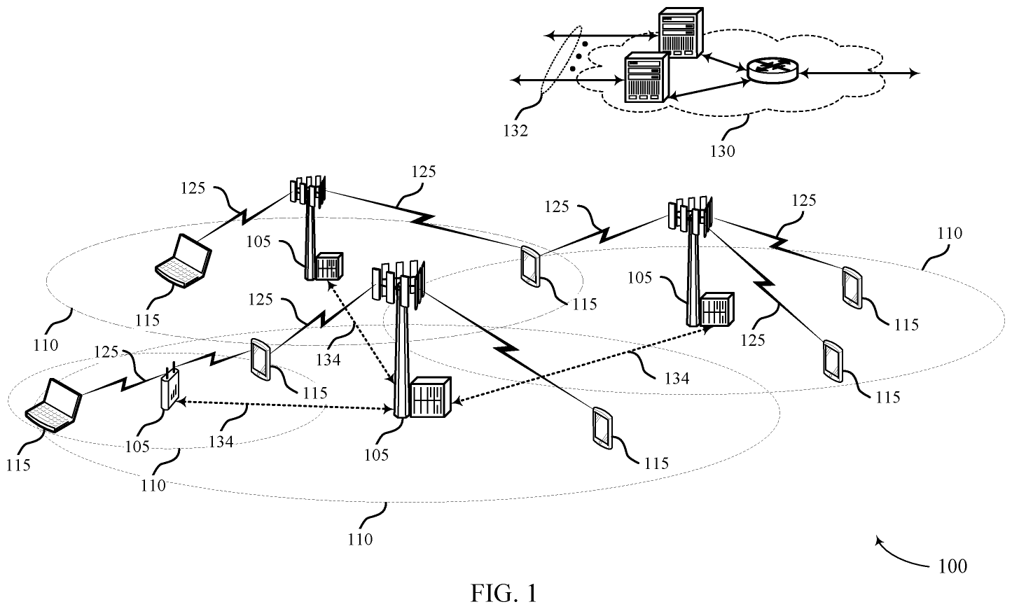

FIG. 1 illustrates an example of a wireless communications system 100 that supports multi-operator personalization at a single SKU in accordance with aspects of the present disclosure. The wireless communications system 100 includes base stations 105, UEs 115, and a core network 130. In some examples, the wireless communications system 100 may be a Long-Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” may refer to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use hybrid automatic repeat request (HARD) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical layer, transport channels may be mapped to physical channels.

Wireless communications system 100 may support communications between UEs 115 and base stations 105 within the networks of an operator. A UE 115 may be referred to as an SKU, and UEs 115 or SKUs may be manufactured by OEMs or ODMs. OEMs or ODMs may personalize or lock a UE 115 for operation with a specific operator at the factory. For example, to prepare UEs 115 for two operators (e.g., operators X and Y), an OEM may manufacture a first set of UEs 115 issued with software specific to a first operator (e.g., operator X), and the OEM may manufacture a second set of UEs 115 issued with software specific to a second operator (e.g., operator Y). That is, the OEM would manufacture or configure UEs 115 differently for different operators to meet the subsidy requirements for the operators (e.g., the UEs 115 may be made to stock). As such, an operator may sell UEs 115 personalized or locked for operation with its networks at a subsidized price (i.e., the operator may work with OEMs or ODMs to subsidize its UEs).

The configuration to be applied to personalize or lock a UE 115 for operation with a specific operator may be referred to as an operator configuration. The operator configuration may include a personalization configuration which the UE 115 may use to validate a subscriber identity module (SIM) inserted in the UE 115 (e.g., to restrict the usage of other operator SIM cards on a UE 115 that is subsidized for a specific operator). To validate the SIM, the UE 115 may retrieve the codes for each activated personalization category stored at the UE 115 and the relevant codes from the SIM, and the UE 115 may check the codes stored at the UE 115 against the codes retrieved from the SIM to determine whether to validate the SIM and allow the UE 115 to go into normal operation. Since the UE 115 will not go into normal operation unless the checks pass for each personalization category, and the codes stored at the UE 115 for each personalization category may be specific to an operator, the UE 115 may be said to be locked for operation with the operator. Table 1 below illustrates an example of the codes used for each personalization category.

TABLE 1
Codes used by each personalization category

| | | Network | | | SIM/USIM |
|---|---|---|---|---|---|
| | Network | Subset | | | (IMSI |
| | (MCC, | (IMSI digits | Service | | digits |
| Code | MNC) | 6 and 7) | Provider | Corporate | 8 to 15) |
| Personalization | | | | | |
| Category | | | | | |
| Network | X | | | | |
| Network | X | X | | | |
| subset | | | | | |
| SP | X | | X | | |
| Corporate | X | | X | X | |
| SIM/USIM | X | X | | | X |

In some cases, it may be challenging for an operator to anticipate sales. As a result, an OEM or ODM may manufacture a surplus of UEs 115 for the operator, and, since the UEs 115 may be personalized or locked for operation with the operator, the UEs 115 may only support operation with that operator. Accordingly, the UEs 115 may have to be sent back to the factory to be re-personalized or locked for operation with another operator (e.g., where the manufacturer may reconfigure and issue the UEs 115 with software for the other operator). This back and forth between operators and manufacturers may be common and may result in operational inefficiencies and increased costs.

To limit such back and forth, a UE 115 or a component within the UE may support efficient techniques for dynamically personalizing or locking the UE for operation with a specific operator (e.g., based on user input). For example, the UE 115 may store multiple operator configurations associated with multiple operators, and, once a user selects an operator (e.g., via a user interface on the UE), the UE may apply the operator configuration corresponding to the selected operator to personalize or lock the UE 115 for operation with the selected operator. Thus, a single UE 115 or SKU may be capable of storing operator configurations (e.g., including personalization configurations) for multiple operators such that the UE 115 or SKU may be personalized later on (e.g., assembled to order) for one of the multiple operators (e.g., an OEM may prepare one SKU with the ability to be locked later for operation with operator X, Y, or Z).

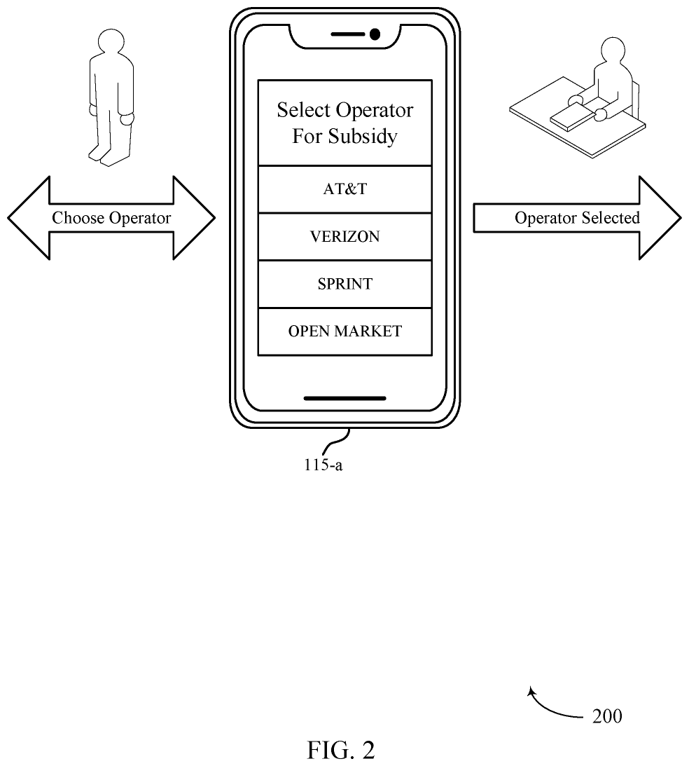

FIG. 2 illustrates an example of a user interface 200 at a UE 115-a that supports multi-operator personalization at a single SKU in accordance with aspects of the present disclosure. While booting up, the UE 115-a may read a list of available operator configurations at the UE 115-a (e.g., a list of operator configurations stored at the UE 115-a) corresponding to the operators supported by UE 115-a, and UE 115-a may prompt a user to select an operator from a list of the operators (as shown). It is to be understood that selecting the operator via the user interface 200 is one way of selecting an operator, and alternative procedures for selecting an operator may be supported.

Once the user selects an operator (e.g., AT&T, Verizon, Sprint, or open market), the UE 115-a may select and apply an operator configuration corresponding to the selected operator to personalize or lock the UE 115-a for operation with the selected operator. The operator configuration may include an operator agent (e.g., a personalization android application package (APK) or other executable code), a personalization configuration, and a public key. Thus, when the UE 115-a selects the operator configuration, the UE 115-a may select the operator agent, personalization configuration, and public key to apply to lock the UE 115-a for operation with the selected operator.

As an example, the initial factory configuration of the UE 115-a may include operator configurations for three operators (e.g., AT&T, Verizon, and Sprint). Accordingly, the UE 115-a may store operator agents for AT&T, Verizon, and Sprint in the trust zone (e.g., at the application processor of the UE 115-a) or in some other storage. The UE 115-a may also store inactive personalization configurations for AT&T, Verizon, and Sprint in secure file storage (e.g., at the modem of the UE 115-a) or in some other storage. Further, the UE 115-a may store public keys for AT&T, Verizon, and Sprint in secure file storage (e.g., at the modem of the UE 115-a) or in some other storage.

Thus, in some cases, when a user selects the operator, the UE 115-a may select or retrieve the corresponding operator agent, personalization configuration, and public key from storage (e.g., where the operator agent, personalization configuration, and public key may be stored in the trust zone once an operator is selected). In one example, the operator agent, personalization configuration, and public key may be bound with a unique reference key and, when the user selects the operator (e.g., during deployment or re-personalization), the UE 115-a may retrieve the corresponding operator agent, personalization configuration, and public key (e.g., the triplet) from storage using the reference key. In other cases, the UE 115-a may receive the operator agent, personalization configuration, or public key over the air from a base station 105.

The UE 115-a may then use the operator agent (e.g., deployed by the operator in the UE 115-a) to communicate with the operator server (e.g., AT&T server if the selected operator is AT&T) to activate service with the operator (e.g., to get the needed approvals for allowing the UE 115 to work). As described with reference to FIG. 1, the UE 115-a may use the personalization configuration to validate the SIM card inserted in the UE 115-a (e.g., by checking codes retrieved from the SIM against codes associated with the personalization configuration corresponding to the selected operator that is stored at the UE 115-a). In addition, the UE 115-a may use the public key to validate the signatures of messages received from the network and to encrypt responses to the operator server.

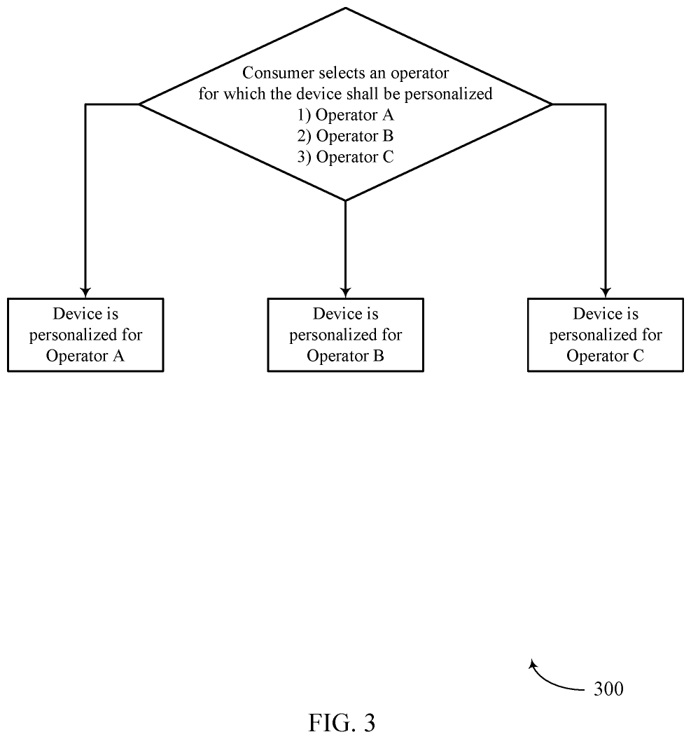

FIG. 3 illustrates an example of a flowchart 300 that supports multi-operator personalization at a single SKU in accordance with aspects of the present disclosure. In the example of FIG. 3, a consumer may select an operator for which a UE 115 may be personalized from a list of operators (e.g., operators A, B, and C). The UE 115 may then select and apply (or enable) an operator configuration corresponding to the selected operator to personalize or lock the UE 115 for operation with the selected operator (e.g., operator A, B, or C). Using these techniques, a UE 115 may be dynamically or flexibly personalized or locked for operation with the selected operator at deployment or the UE 115 may be seamlessly re-personalized or locked to a different operator (e.g., after being previously locked for operation with one operator). This flexibility to be seamlessly moved, re-personalized, or locked to a different operator may result in improved operational efficiency and reduced costs (e.g., especially for UEs including a universal integrated circuit card (UICC) that supports multiple operator profiles).

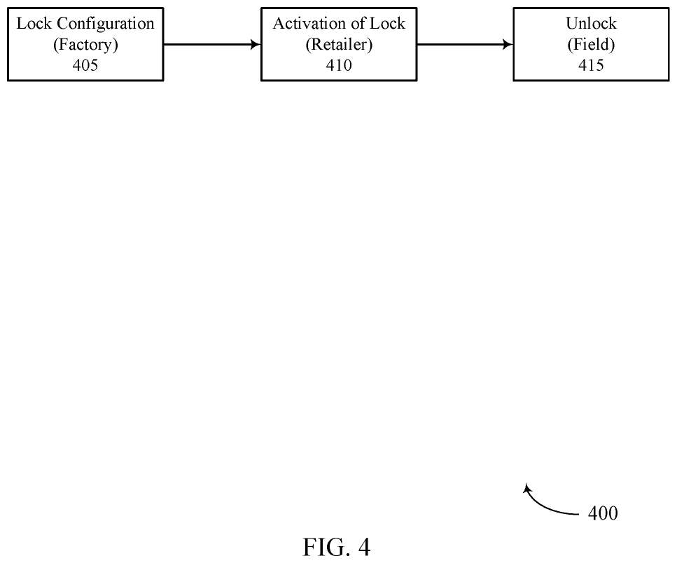

FIG. 4 illustrates an example of a flowchart 400 that supports multi-operator personalization at a single SKU in accordance with aspects of the present disclosure. In the example of FIG. 4, a UE 115 may receive a lock configuration 405 at the factory including the operator configurations for multiple operators (e.g., where the operator configurations may be inactive). The UE 115 may then receive a request (e.g., an activation of lock 410) to be personalized or locked for operation with a specific operator (e.g., based on a user selecting an operator at the retailer when purchasing a subsidized device), and the UE 115 may apply (or enable) an operator configuration for the specific operator to personalize or lock the UE 115 for operation with the specific operator (e.g., the lock configuration for the specific operator is activated).

In some cases, after the UE 115 is locked for operation with one operator, a user may want to unlock the device (e.g., using an unlock field 415). In such cases, the user may use a control key to unlock the UE 115, or the UE 115 may be unlocked through signature validation initiated by an operator agent (e.g., APK). Once the UE 115 is unlocked, the UE 115 may be re-personalized or re-locked for operation with a different operator (or the same operator). Thus, a user may be able to re-personalize or re-lock a UE 115 originally locked to a first operator (e.g., a lock is active to operator X) to a second operator (e.g., operator Y). This, unlocking and re-locking procedure may be supported by the first operator through options provide by the first operator or an OEM. In the case of re-personalization of a UE 115, the existing active operator configuration (e.g., operator agent, personalization configuration, and public key) is pushed back to the trust zone and the newly intended operator configuration (e.g., operator agent, personalization configuration, and public key) may be applied on the UE 115 (e.g., when a user downloads another operator profile on a UICC and switches to another operator for subsidy enablement).

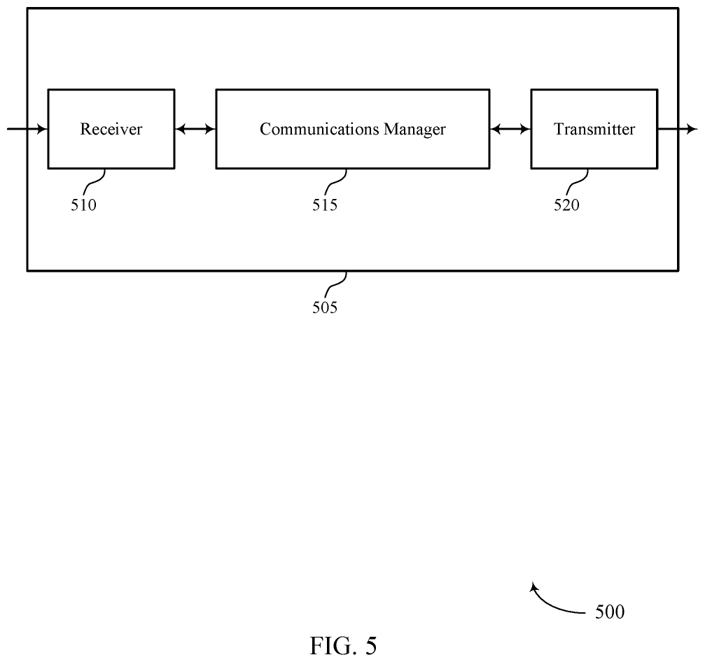

FIG. 5 shows a block diagram 500 of a device 505 that supports multi-operator personalization at a single SKU in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

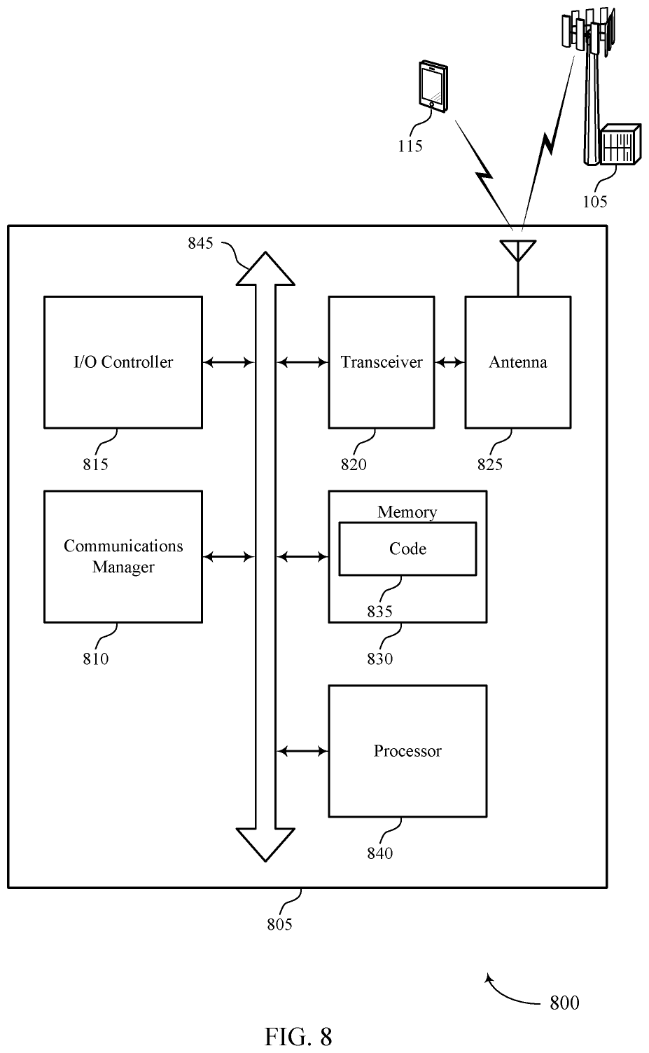

The receiver 510 may receive information such as packets, user data, or control information associated with various information channels (e.g., control channels, data channels, and information related to multi-operator personalization at a single SKU, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may receive an indication of an operator selected for the UE from a set of operators, receive an operator configuration corresponding to the selected operator, the operator configuration including an operator agent, lock the UE for operation via the selected operator by applying the operator configuration corresponding to the selected operator, and communicate with a server of the selected operator using the operator agent to activate service with the operator. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a digital signal processor (DSP), an application-specific integrated circuit (ASIC), a field-programmable gate array (FPGA), or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

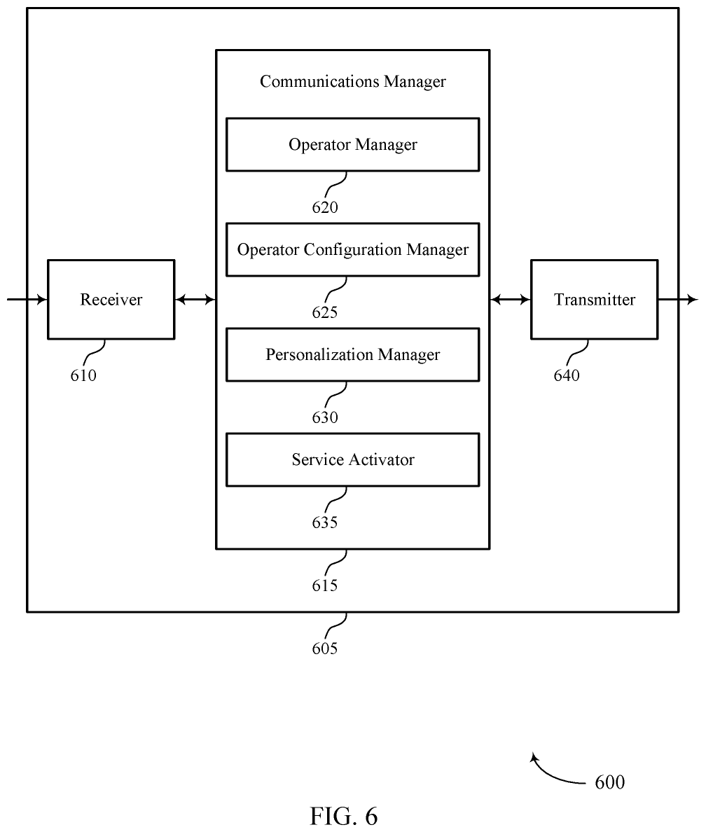

FIG. 6 shows a block diagram 600 of a device 605 that supports multi-operator personalization at a single SKU in accordance with aspects of the present disclosure. The device 605 may be an example of aspects of a device 505, or a UE 115 as described herein. The device 605 may include a receiver 610, a communications manager 615, and a transmitter 640. The device 605 may also include a processor. Each of these components may be in communication with one another (e.g., via one or more buses).

The receiver 610 may receive information such as packets, user data, or control information associated with various information channels (e.g., control channels, data channels, and information related to multi-operator personalization at a single SKU, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include an operator manager 620, an operator configuration manager 625, a personalization manager 630, and a service activator 635. The communications manager 615 may be an example of aspects of the communications manager 810 described herein.

The operator manager 620 may receive an indication of an operator selected for the UE from a set of operators. The operator configuration manager 625 may receive an operator configuration corresponding to the selected operator, the operator configuration including an operator agent (e.g., the device 605 or operator configuration manager 625 may select the operator configuration, the operator configuration manager 625 may receive the indication of the operator configuration from another component within the UE, or the device 605 or operator configuration manager 625 may receive the indication of the operator selected over the air). The personalization manager 630 may lock the UE for operation via the selected operator by applying the operator configuration corresponding to the selected operator. The service activator 635 may communicate with a server of the selected operator using the operator agent to activate service with the operator.

The transmitter 640 may transmit signals generated by other components of the device 605. In some examples, the transmitter 640 may be collocated with a receiver 610 in a transceiver module. For example, the transmitter 640 may be an example of aspects of the transceiver 820 described with reference to FIG. 8. The transmitter 640 may utilize a single antenna or a set of antennas.

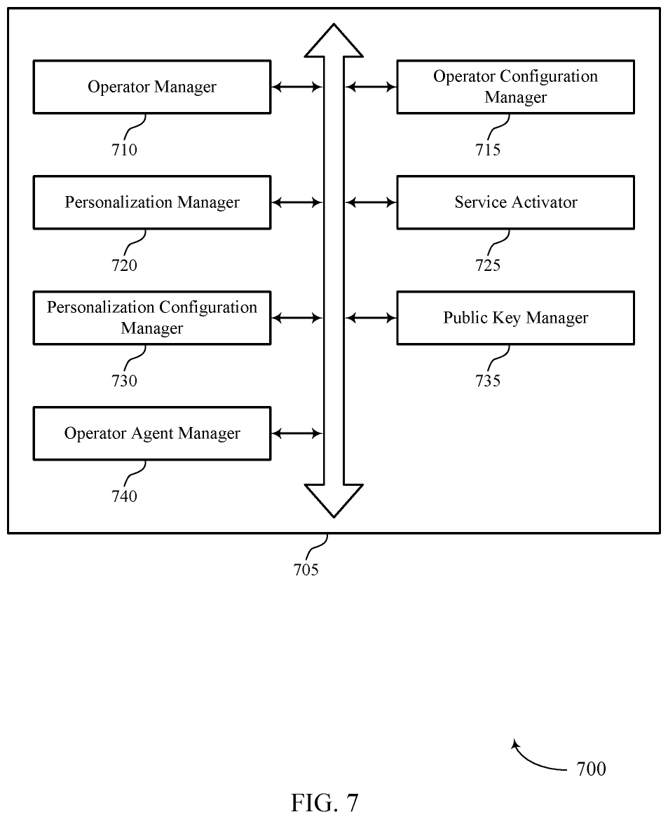

FIG. 7 shows a block diagram 700 of a communications manager 705 that supports multi-operator personalization at a single SKU in accordance with aspects of the present disclosure. The communications manager 705 may be an example of aspects of a communications manager 515, a communications manager 615, or a communications manager 810 described herein. The communications manager 705 may include an operator manager 710, an operator configuration manager 715, a personalization manager 720, a service activator 725, a personalization configuration manager 730, a public key manager 735, and an operator agent manager 740. Each of these modules may communicate, directly or indirectly, with one another (e.g., via one or more buses).

The operator manager 710 may receive an indication of an operator selected for the UE from a set of operators. In some cases, the UE includes a UICC supporting the set of operators. In some cases, the UE is a single SKU, the single SKU supporting the set of operators and being dynamically configured for operation via the selected operator. The operator configuration manager 715 may receive an operator configuration corresponding to the selected operator, the operator configuration including an operator agent.

In some examples, the operator configuration manager 715 may select and enable the operator configuration corresponding to the selected operator. In some examples, the operator configuration manager 715 may select a reference key corresponding to the selected operator. In some examples, the operator configuration manager 715 may receive the operator configuration corresponding to the selected operator using the reference key. In some cases, an operator agent, personalization configuration, and public key corresponding to each operator of the set of operators are bound together with a unique reference key.

The personalization manager 720 may lock the UE for operation via the selected operator by applying the operator configuration corresponding to the selected operator. In some cases, the UE is locked for operation via the selected operator during deployment or as part of a re-personalization procedure. The service activator 725 may communicate with a server of the selected operator using the operator agent to activate service with the operator. The personalization configuration manager 730 may receive a personalization configuration corresponding to the selected operator.

In some examples, the personalization configuration manager 730 may utilize the personalization configuration to check codes saved at the UE for a set of personalization categories against codes retrieved from a SIM inserted at the UE. In some cases, a set of personalization configurations corresponding to the set of operators are stored in secure file storage at the UE, and where the received personalization configuration is one of the set of personalization configurations. The public key manager 735 may receive a public key corresponding to the selected operator. In some examples, the public key manager 735 may utilize the public key to validate signatures of messages received from the server of the selected operator or to encrypt responses to the server of the selected operator. In some cases, a set of public keys corresponding to the set of operators are stored in secure file storage at the UE, and where the received public key is one of the set of public keys. The operator agent manager 740 may receive an operator agent corresponding to the selected operator. In some examples, the operator agent manager 740 may utilize the operator agent to communicate with an operator server. In some cases, a set of operator agents corresponding to the set of operators are stored in a trust zone at the UE, and where the received operator agent is one of the set of operator agents.

FIG. 8 shows a diagram of a system 800 including a device 805 that supports multi-operator personalization at a single SKU in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may receive an indication of an operator selected for the UE from a set of operators, receive an operator configuration corresponding to the selected operator, the operator configuration including an operator agent, lock the UE for operation via the selected operator by applying the operator configuration corresponding to the selected operator, and communicate with a server of the selected operator using the operator agent to activate service with the operator.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described herein. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include random-access memory (RAM) and read-only memory (ROM). The memory 830 may store computer-readable, computer-executable code 835 including instructions that, when executed, cause the processor to perform various functions described herein. In some cases, the memory 830 may contain, among other things, a basic I/O system (BIOS) which may control basic hardware or software operation such as the interaction with peripheral components or devices.

The processor 840 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting multi-operator personalization at a single SKU).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

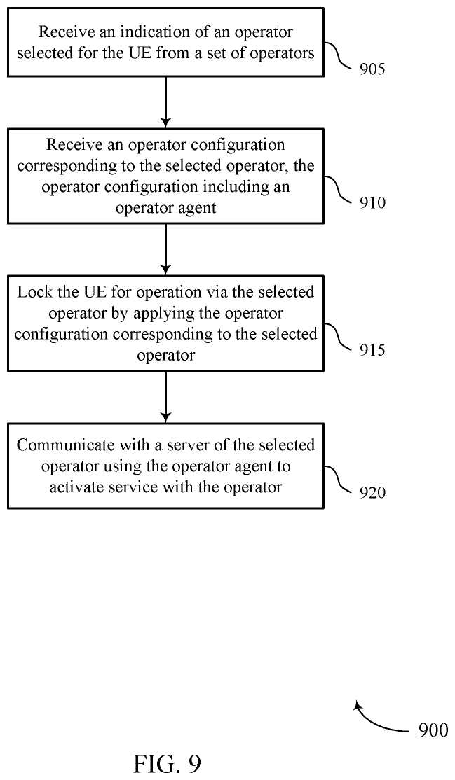

FIG. 9 shows a flowchart illustrating a method 900 that supports multi-operator personalization at a single SKU in accordance with aspects of the present disclosure. The operations of method 900 may be implemented by a UE 115 or its components as described herein. For example, the operations of method 900 may be performed by a communications manager as described with reference to FIGS. 5 through 8. In some examples, a UE may execute a set of instructions to control the functional elements of the UE to perform the functions described herein. Additionally, or alternatively, a UE may perform aspects of the functions described herein using special-purpose hardware.

At 905, the UE may receive an indication of an operator selected for the UE from a set of operators. The operations of 905 may be performed according to the methods described herein. In some examples, aspects of the operations of 905 may be performed by an operator manager as described with reference to FIGS. 5 through 8.

At 910, the UE may receive an operator configuration corresponding to the selected operator, the operator configuration including an operator agent. The operations of 910 may be performed according to the methods described herein. In some examples, aspects of the operations of 910 may be performed by an operator configuration manager as described with reference to FIGS. 5 through 8.

At 915, the UE may lock the UE for operation via the selected operator by applying the operator configuration corresponding to the selected operator. The operations of 915 may be performed according to the methods described herein. In some examples, aspects of the operations of 915 may be performed by a personalization manager as described with reference to FIGS. 5 through 8.

At 920, the UE may communicate with a server of the selected operator using the operator agent to activate service with the operator. The operations of 920 may be performed according to the methods described herein. In some examples, aspects of the operations of 920 may be performed by a service activator as described with reference to FIGS. 5 through 8.

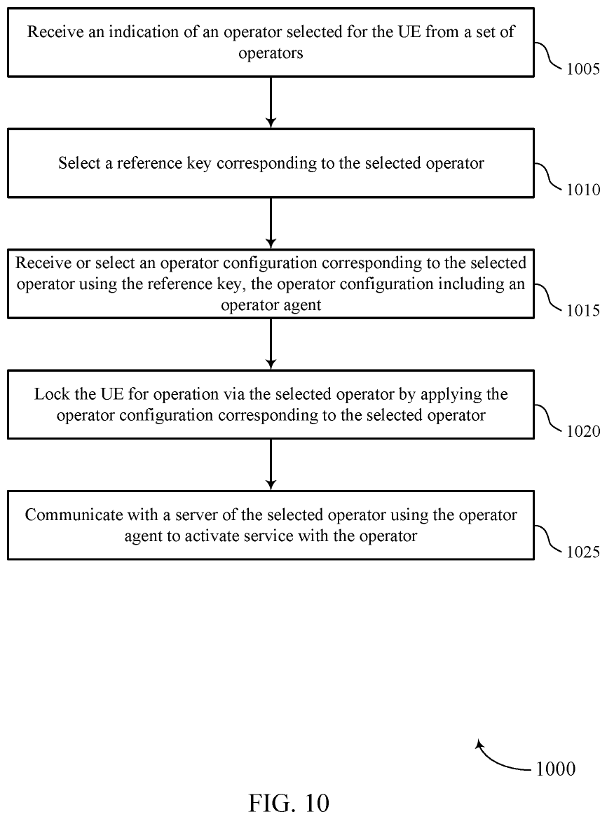

FIG. 10 shows a flowchart illustrating a method 1000 that supports multi-operator personalization at a single SKU in accordance with aspects of the present disclosure. The operations of method 1000 may be implemented by a UE 115 or its components as described herein. For example, the operations of method 1000 may be performed by a communications manager as described with reference to FIGS. 5 through 8. In some examples, a UE may execute a set of instructions to control the functional elements of the UE to perform the functions described herein. Additionally, or alternatively, a UE may perform aspects of the functions described herein using special-purpose hardware.

At 1005, the UE may receive an indication of an operator selected for the UE from a set of operators. The operations of 1005 may be performed according to the methods described herein. In some examples, aspects of the operations of 1005 may be performed by an operator manager as described with reference to FIGS. 5 through 8.

At 1010, the UE may select a reference key corresponding to the selected operator, wherein an operator agent, personalization configuration, and public key corresponding to the selected operator is bound together with the reference key. The operations of 1010 may be performed according to the methods described herein. In some examples, aspects of the operations of 1010 may be performed by an operator configuration manager as described with reference to FIGS. 5 through 8.

At 1015, the UE may receive or select an operator configuration corresponding to the selected operator using the reference key, the operator configuration including an operator agent. The operations of 1015 may be performed according to the methods described herein. In some examples, aspects of the operations of 1015 may be performed by an operator configuration manager as described with reference to FIGS. 5 through 8.

At 1020, the UE may lock the UE for operation via the selected operator by applying the operator configuration corresponding to the selected operator. The operations of 1020 may be performed according to the methods described herein. In some examples, aspects of the operations of 1020 may be performed by a personalization manager as described with reference to FIGS. 5 through 8.

At 1025, the UE may communicate with a server of the selected operator using the operator agent to activate service with the operator. The operations of 1025 may be performed according to the methods described herein. In some examples, aspects of the operations of 1025 may be performed by a service activator as described with reference to FIGS. 5 through 8.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the herein are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a user equipment (UE), comprising:
receiving an indication of a selected operator for the UE from a plurality of operators;
receiving an operator configuration corresponding to the selected operator, the operator configuration comprising an operator agent;
locking the UE for operation via the selected operator by applying the operator configuration corresponding to the selected operator; and
communicating with a server of the selected operator using the operator agent to activate service with the selected operator.

2. The method of claim 1, wherein receiving the operator configuration corresponding to the selected operator comprises:
selecting and enabling the operator configuration corresponding to the selected operator.

3. The method of claim 1, wherein receiving the operator configuration corresponding to the selected operator comprises:
receiving a personalization configuration corresponding to the selected operator; and
utilizing the personalization configuration to check codes saved at the UE for a plurality of personalization categories against codes retrieved from a subscriber identity module (SIM) inserted at the UE.

4. The method of claim 3, wherein a plurality of personalization configurations corresponding to the plurality of operators are stored in secure file storage at the UE, and wherein the personalization configuration is one of the plurality of personalization configurations.

5. The method of claim 3, wherein receiving the personalization configuration corresponding to the selected operator comprises:
receiving a public key corresponding to the selected operator; and
utilizing the public key to validate signatures of messages received from the server of the selected operator or to encrypt responses to the server of the selected operator.

6. The method of claim 1, wherein a plurality of operator agents corresponding to the plurality of operators are stored in a trust zone at the UE, and wherein the operator agent is one of the plurality of operator agents.

7. The method of claim 1, wherein the operator agent, personalization configuration, and public key corresponding to each operator of the plurality of operators are bound together with a unique reference key.

8. The method of claim 7, wherein receiving the operator configuration corresponding to the selected operator comprises:
selecting a reference key corresponding to the selected operator; and
receiving the operator configuration corresponding to the selected operator using the reference key.

9. The method of claim 1, wherein the UE is locked for operation via the selected operator during deployment or as part of a re-personalization procedure.

10. The method of claim 1, wherein the UE is a single stock keeping unit (SKU), the single SKU supporting the plurality of operators and being dynamically configured for operation via the selected operator.

11. An apparatus for wireless communication at a user equipment (UE), comprising:
a processor,
memory in electronic communication with the processor; and
instructions stored in the memory and executable by the processor to cause the apparatus to:
receive an indication of a selected operator for the UE from a plurality of operators;
receive an operator configuration corresponding to the selected operator, the operator configuration comprising an operator agent;
lock the UE for operation via the selected operator by applying the operator configuration corresponding to the selected operator; and
communicate with a server of the selected operator using the operator agent to activate service with the selected operator.

12. The apparatus of claim 11, wherein the instructions to receive the operator configuration corresponding to the selected operator are executable by the processor to cause the apparatus to:
receive a personalization configuration corresponding to the selected operator; and
utilize the personalization configuration to check codes saved at the UE for a plurality of personalization categories against codes retrieved from a subscriber identity module (SIM) inserted at the UE.

13. The apparatus of claim 12, wherein a plurality of personalization configurations corresponding to the plurality of operators are stored in secure file storage at the UE, and wherein the personalization configuration is one of the plurality of personalization configurations.

14. The apparatus of claim 11, wherein the instructions to receive the personalization configuration corresponding to the selected operator are executable by the processor to cause the apparatus to:
receive a public key corresponding to the selected operator; and
utilize the public key to validate signatures of messages received from the server of the selected operator or to encrypt responses to the server of the selected operator.

15. The apparatus of claim 11, wherein a plurality of operator agents corresponding to the plurality of operators are stored in a trust zone at the UE, and wherein the operator agent is one of the plurality of operator agents.

16. The apparatus of claim 11, wherein the operator agent, personalization configuration, and public key corresponding to each operator of the plurality of operators are bound together with a unique reference key.

17. The apparatus of claim 11, wherein the UE is locked for operation via the selected operator during deployment or as part of a re-personalization procedure.

18. The apparatus of claim 11, wherein the UE is a single stock keeping unit (SKU), the single SKU supporting the plurality of operators and being dynamically configured for operation via the selected operator.

19. An apparatus for wireless communication at a user equipment (UE), comprising:
means for receiving an indication of a selected operator for the UE from a plurality of operators;
means for receiving an operator configuration corresponding to the selected operator, the operator configuration comprising an operator agent;
means for locking the UE for operation via the selected operator by applying the operator configuration corresponding to the selected operator; and
means for communicating with a server of the selected operator using the operator agent to activate service with the selected operator.

20. The apparatus of claim 19, wherein the means for receiving the operator configuration corresponding to the selected operator comprises:
means for receiving a personalization configuration corresponding to the selected operator; and
means for utilizing the personalization configuration to check codes saved at the UE for a plurality of personalization categories against codes retrieved from a subscriber identity module (SIM) inserted at the UE.

21. The apparatus of claim 20, wherein a plurality of personalization configurations corresponding to the plurality of operators are stored in secure file storage at the UE, and wherein the personalization configuration is one of the plurality of personalization configurations.

22. The apparatus of claim 19, wherein the means for receiving the personalization configuration corresponding to the selected operator comprises:
means for receiving a public key corresponding to the selected operator; and
means for utilizing the public key to validate signatures of messages received from the server of the selected operator or to encrypt responses to the server of the selected operator.

23. The apparatus of claim 19, wherein a plurality of operator agents corresponding to the plurality of operators are stored in a trust zone at the UE, and wherein the operator agent is one of the plurality of operator agents.

24. The apparatus of claim 19, wherein the operator agent, personalization configuration, and public key corresponding to each operator of the plurality of operators are bound together with a unique reference key.

25. The apparatus of claim 19, wherein the UE is locked for operation via the selected operator during deployment or as part of a re-personalization procedure.

26. The apparatus of claim 19, wherein the UE is a single stock keeping unit (SKU), the single SKU supporting the plurality of operators and being dynamically configured for operation via the selected operator.

27. A non-transitory computer-readable medium storing code for wireless communication at a user equipment (UE), the code comprising instructions executable by a processor to:
receive an indication of a selected operator for the UE from a plurality of operators;
receive an operator configuration corresponding to the selected operator, the operator configuration comprising an operator agent;
lock the UE for operation via the selected operator by applying the operator configuration corresponding to the selected operator; and
communicate with a server of the selected operator using the operator agent to activate service with the selected operator.

28. The non-transitory computer-readable medium of claim 27, wherein the instructions to receive the operator configuration corresponding to the selected operator are executable to:
receive a personalization configuration corresponding to the selected operator; and
utilize the personalization configuration to check codes saved at the UE for a plurality of personalization categories against codes retrieved from a subscriber identity module (SIM) inserted at the UE.

29. The non-transitory computer-readable medium of claim 27, wherein the UE is locked for operation via the selected operator during deployment or as part of a re-personalization procedure.

30. The non-transitory computer-readable medium of claim 27, wherein the UE is a single stock keeping unit (SKU), the single SKU supporting the plurality of operators and being dynamically configured for operation via the selected operator.
